(19) United States
(12) Patent Application Publication
(10) Pub. No.: US 2024/0118752 A1
(43) Pub. Date: Apr. 11, 2024

(54) Ergonomic Keyboard

(71) Applicant: Michael G. Johnson, Printer, KY (US)

(72) Inventor: Michael G. Johnson, Printer, KY (US)

(21) Appl. No.: 18/092,310

(22) Filed: Dec. 31, 2022

Related U.S. Application Data
(60) Provisional application No. 63/413,356, filed on Oct. 5, 2022.

(51) Int. Cl. G06F 3/02

(52) U.S. Cl. CPC G06F 3/0219

(57) ABSTRACT

An easy to learn, ergonomic, and sequentially arranged keyboard configuration is described which reduces angular movement of a user's outside three fingers and thus reduces repetitive motion injuries induced by angular movement of the outside three fingers while minimizing mis-strikes.

### CROSS REFERENCE

This application claims priority from U.S. Provisional Patent Application 63/413,356 filed on Oct. 5, 2022 and entitled Ergonomic Keyboard Configuration.

### TECHNICAL FIELD

The apparatus of the present application relates generally to ergonomic devices for computer accessories to minimize the risk and effect of Carpal Tunnel Syndrome and other repetitive motion injuries related to the overuse of the hands and fingers. More specifically, the apparatus of the present application relates to ergonomic keyboard configurations that minimize the use of the wrist when typing.

### BACKGROUND

Along with the rapid growth of machine automation and the widespread personal and professional use of computers, there has been an increase in repetitive stress injuries. These injuries include upper limb disorders such as Carpal Tunnel Syndrome, cumulative trauma disorder, and occupational overuse syndrome. While operating a traditional “QWERTY” keyboard, the hands generally remain stationary except for some rotational movement at the wrist, allowing the fingers to accomplish most of the work in a repetitive impact motion which can cause excessive use and chronic fatigue of the muscles and tendons, causing the tendons to swell, and at the same time, squeezing the median nerve as it passes through the wrist ligament. This leads to pain and discomfort, and it is commonly associated with symptoms such as numbness, burning, and tingling sensations in the hands and arms. These symptoms are commonly associated with Carpal Tunnel Syndrome, an affliction whereby there is median nerve compression with symptoms in the hands and arm where the nerve runs. Medical treatments for this condition include physical therapy and surgery to relieve the pressure on the median nerve, usually through a tendon release. Many patients are undergoing multiple surgeries, which can cause complications ranging from excessive scar tissue overgrowth (re-compressing the nerve tunnel) to repetitive motion injuries that leave the fingers totally devoid of sensation. Some studies estimate that between 3% to 6% of the general population in the United States are afflicted with Carpal Tunnel Syndrome, with up to 50% of those cases being affected in both hands. FIG. 1 presents data on the prevalence of Carpal Tunnel Syndrome by industry based on research reported in the Journal of American Medicine in 1999.

Ergonomic disorders are the fastest-growing category of work-related illness. According to the most recent statistics from the U.S. Bureau of Labor Statistics, they account for approximately 56 percent of illnesses reported to the Occupational Safety and Health Administration. The U.S. Department of Labor has concluded that Carpal Tunnel Syndrome is the “chief occupational hazard of the 90's” and disabled workers in epidemic proportions. According to the National Institute for Occupational Safety and Health (NIOSH), only 23% of all Carpal Tunnel Syndrome patients were able to return to their previous professions following surgery. More than eight million people in the United States are affected by Carpal Tunnel Syndrome each year. Surgery for Carpal Tunnel Syndrome is the second most common type of musculoskeletal surgery, with well over 230,000 procedures performed annually.

Frequent users of personal computers are at risk for a repetitive stress injury when interacting with the device through a standard keyboard configuration. Stress injuries arise from accumulative strain on the limbs over a period of time. In contrast to using a traditional manual typewriter, the computer keyboard user no longer takes breaks from data input for carriage returns, error corrections, and paper insertions. Instead, the user achieves the equivalent of these functions with additional keystrokes, never removing the hands from the keyboard or repositioning the arms to reach for items such as correction fluid, paper, or an adding machine.

The frequent use of a traditional keyboard places a continuous strain on the fingers and upper limbs, especially due to the stress of the constant impact from the keyboard. When each key reaches the bottom of a keystroke, it “bottoms out,” causing a small impact to the fingers as the key hits onto a hard plastic surface or non-resilient material. The vibration of impact travels up the hand and arm, stressing the soft tissues such as the muscles, tendons, and ligaments. This is similar to the vibration of impact traveling up the leg of a runner when his foot hits the ground, causing his muscles and joints to become sore. Typing on a keyboard without any cushion for the impact of the keys is similar to a person running without cushioning in his shoes, quickly leading to soreness and pain if done continuously, and contributing to the development of a repetitive stress injury.

Carpal Tunnel Syndrome is caused by compression of the median nerve which travels from the neck to the fingers, through the upper arm, forearm, wrist, and hand. The palmar carpal ligament wraps around the bones of the wrist, otherwise known as the carpals, to form the carpal tunnel. The muscles of the forearm are attached by the tendons to the fingers and travel underneath the carpal ligament, as does the median nerve.

Carpal Tunnel Syndrome occurs when the tissues in the carpal tunnel become irritated and as a result, swell and eventually compress the median nerve, causing the symptoms noted above. Traditional writings on Carpal Tunnel Syndrome have identified the cause of the irritation and swelling variously as chronic fatigue of the muscles, overuse of the tendons, and rubbing of the tendons, muscles and bones due to repetitive use of the hands and fingers. Holding the wrists in “unnatural” positions induces the rubbing of tendons and contributes to muscle fatigue. The position of the wrist while typing on a conventional keyboard has been cited as a major contributor to Carpal Tunnel Syndrome.

As a result of the above diagnosis of the cause of Carpal Tunnel Syndrome, the prior art approaches to preventing these injuries include adjusting the work environment to better fit the user's body. These ergonomic adjustments include the use of wrist pads, split keyboards, keyboard replacements, and keyboards and drawers with wrist supports unitarily formed within. Devices such as the split keyboard create a “natural” position of the user's wrists while typing. These devices, however, have not significantly reduced the incidence of Carpal Tunnel Syndrome.

Moreover, the present-day arrangement of letters on a keyboard, in what is called a “QWERTY” keyboard layout, has remained essentially unchanged since 1873. The QWERTY keyboard configuration became the standard Latin-script layout in 1878, when it was included with the Remington No. 2 typewriter, the precursor to all modern-day typewriters. The QWERTY keyboard configuration was originally designed with the intent that it would prevent the mechanical printing arms of typewriters from clashing against one another or jamming and was the product of several years of trial and error. In pursuing this goal, one of Sholes's principal design philosophies was the purposeful placement of letters that commonly appear next to one another in the English language apart from one another on the keyboard. However, the QWERTY configuration leads to overuse of the left hand the number of words that are only typed with the left hand vastly outnumber those of the right hand despite the overwhelming majority of users being right-handed.

Alternatives to the QWERTY configuration placed lettered keys on the keyboard based on different philosophies of use. An early alternative to QWERTY, DHIATENSOR, named after the placement of its home row keys, on which 85% of all English words can be typed with the home row keys alone. The most popular alternative keyboard configuration is the DVORAK keyboard layout. DVORAK is a patented non-QWERTY-inspired layout which was intended to fix many of the QWERTY keyboard's shortcomings. DVORAK shifts most of the typing to the right hand, as well as to the home row. On QWERTY keyboards, only 32% of the typing occurs on the home row, as opposed to DVORAK'S 70%. Another alternative is the COLEMAK layout. The COLEMAK layout is based heavily on QWERTY, and thus easier-to-learn than DVORAK. COLEMAK increases home row use to 74% while moving only seventeen keys from their QWERTY position, as opposed to DVORAK's thirty-three.

### SUMMARY OF THE DISCLOSURE

The present application describes an easy to learn and use keyboard layout called ALPHABETTER™, which is based upon the sequential ordering of letters as they were learned as a child and as found sequentially in the user's language. The keys are arranged in linear columns and rows which reduces the unnatural angular movement of the outside three fingers and relying upon the finger adjacent to the thumb for angular striking of keys, which is a natural movement for that finger.

### BRIEF DESCRIPTION OF THE DRAWINGS

FIG. 1 depicts a table which provides data on the incidence of Carpal Tunnel Syndrome among US workers.

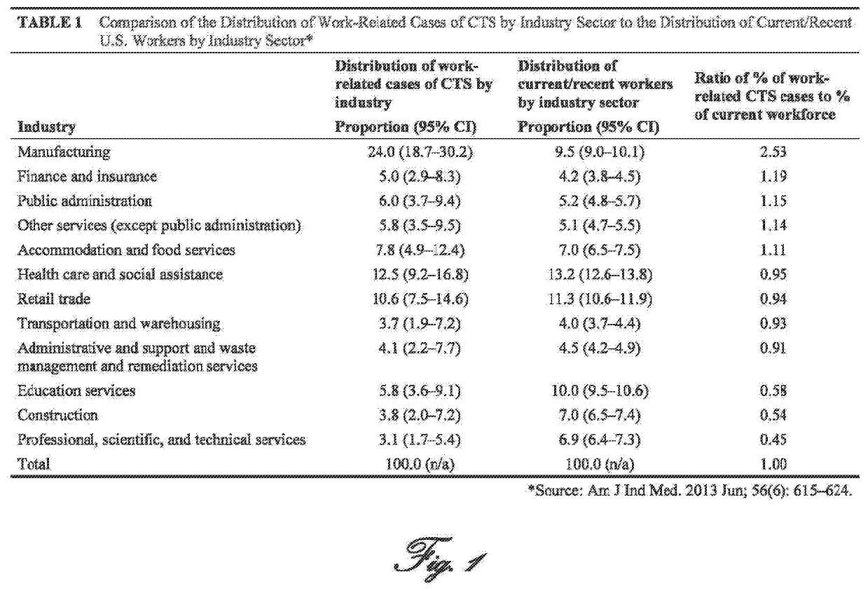

FIG. 2 depicts the keyboard configuration of the preferred embodiment and a sequential arrangement of keys.

### DETAILED DESCRIPTION

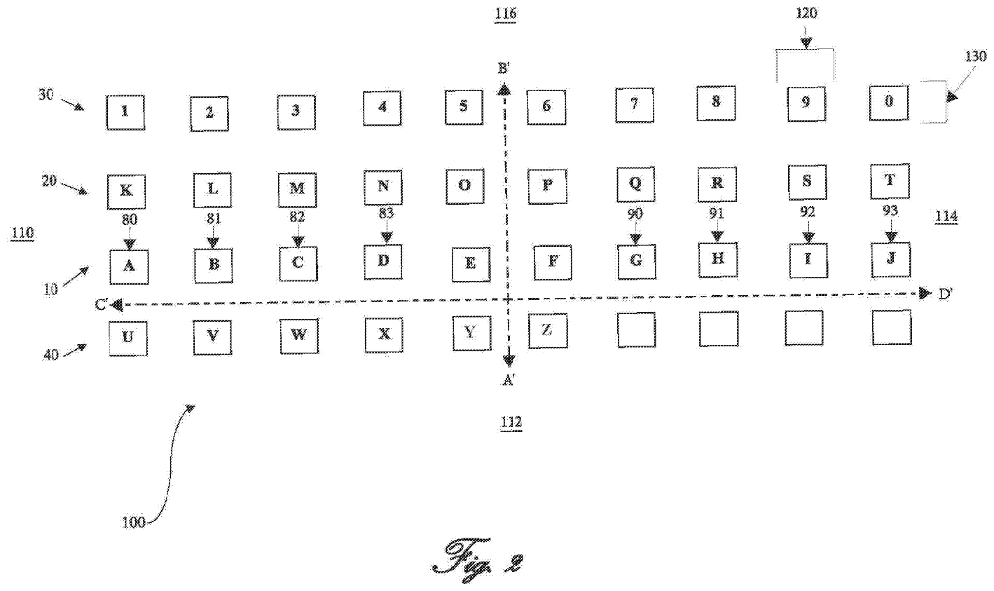

The present application describes a keyboard layout, FIG. 2, called ALPHABETTER, which is based upon the sequential ordering of letters as they were learned as a child and as found sequentially in the user's language. The home letter row 10 (the second key row 10 distally from the user) of the keyboard begins with the letter A for an English language keyboard on the right side of the keyboard 110 and in a preferred embodiment terminates with the key letter J in the English language. The left-to-right sequential arrangement results from the left-to-right reading order of the Germanic, Romance, and Slovak languages but alternative configurations are contemplated for other reading orders utilized in other languages, i.e., Hebrew and Arabic.

The fourth key row 30 arranged distally from the keyboard bottom end 112 adjacent to the user (top key row 30), at the keyboard top end 116, typically consists of numbers ordered 1 through 0 but may optionally be ordered 0 through 9. The third key row 20 as arranged distally from the keyboard bottom end 112 continues sequentially with the letter K through T in a preferred embodiment for the English language but would always continue with the letter after the terminal letter of the home row 10, where the fingers rest typically on the first 80, second 81, third 82, and fourth keys 83 of the home row 10 as well as the seventh 90, eighth 91, ninth 92, and tenth 93 keys of the home row 10, letters A through D and G through H on an English language configured keyboard 100.

Typically, the finger resting on the fourth home row key 83 from the left side of the keyboard 110 is used to strike the keys immediately distal and proximal to that key as well as in an angular motion to strike the fifth key 70 on the third key row 20 and the fifth key 60 on the first key row 40 key as well as the fourth and fifth number keys in the fourth row 30. Typically, the finger resting on the seventh home row key 90 from the left side of the keyboard 110 is used to strike the keys immediately distal and proximal to that key as well as in an angular motion to strike the sixth key on the third key row 20 and the sixth key on the first key row 40 key as well as the sixth and seventh number keys in the fourth row 30.

Each key row key 130 is arranged so that their proximal-distal center axes (A′-B′) of columns of keys 120 is arranged substantially overlap so as to substantially place each key in line in a key column 120 parallel to the proximal-distal axis (A′-B′) from the bottom end of the keyboard 112 to the top end of the keyboard 116 and each key in line with the adjacent key in each key row 130 in substantially a parallel linear arrangement to the left-right axis (C′-D′). This is advantageous to the offset arrangement of the QWERTY keyboard configuration which induces significant, repetitive, angled movements of the fingers and rotation at the wrist. The offset configuration of the QWERTY keyboard also leads to mis-strikes as the fingers often land between two keys thus inputting both letters and requiring correction. The bottom row keys 40 (at the keyboard bottom 112) continue sequentially left-to-right from the terminal letter of the key row 20 immediately beneath the top key row 30.

The number row 30 keys are arranged distally from the keyboard bottom end 112 and adjacent to the keyboard top end 116 and substantially parallel to the top letter row 20 as well as left-right horizontal axis C′-D′. While some finger movement is still necessary to strike all of the keys, the simple forward and back movement of the fingers for most keystrokes minimized inflammation in the tendon that passes through the carpal tunnel. Moreover, the sequential ordering of the keys is easier to learn and use, much as the sequential ordering of the numbered keys on a QWERTY keyboard. This results in a serving pattern (“Remembrance Keying of AlphaBetter Lettering”™) of wise health which reduces injury from the angular repetitive motions of the fingers on a keyboard.

Languages that are read from right-to-left would similarly be sequentially ordered from right-to-left for ease of learning. Right-to-left languages include Arabic, Aramaic, Azeri, Divehi, Fula, Hebrew, Kurdish, N'ko, Persian, Rohingya, Syriac, and Urdu. Modern Chinese, Japanese, and Korean are now written horizontally and read left-to-right, although historically these scripts were read top-to-bottom in columns and right-to-left.

The sequentially ordered key pattern on the keyboard 100 promotes easy, nimble, ergonomic, logical, and memorable rhythms of finger movement by restricting angular finger movement to the two fingers that are adjacent each thumb and ideally arranged and adapted to such movement from the inherently ideal range of motion of each finger. The logical flow of the keying pattern of the keyboard 100 allows the fingers to work in harmony with the mind.

The present apparatus recognizes and addresses the previously mentioned long-felt needs and provides utility in meeting those needs in its various possible embodiments. To one of skill in this art who has the benefits of this disclosure's teachings, other and further objects and advantages will be clear, as well as others inherent therein. The disclosures herein are not intended to limit the scope of the invention, merely to provide context with which to understand the patent claims.

What is claimed is:

1. An ergonomic keyboard comprising keys arranged in substantially linear key rows arranged right-to-left from the perspective of a user and substantially linear columns arranged in a proximal-to-distal orientation from the perspective of a user, wherein the keys are assigned to lettering symbols of a written language wherein they sequentially begin on a second key row of said keyboard and from a left end of said second key row for written languages read left-to-right and at a right end of said second key row for written languages read right-to-left.

2. The keyboard of claim 1, wherein sequential lettering continues on a third key row distal from said user resuming with the next sequential letter following the terminal letter on said second key row and arranged in the same directional order as said second key row.

3. The keyboard of claim 2, wherein sequential lettering continues on a first key row distal from said user resuming with the next sequential letter following the terminal letter on said third row and arranged in the same directional order as said third row.

4. The keyboard of claim 3, wherein keys are assigned sequential numbering on a fourth key row distal from said user.

5. The keyboard of claim 3, wherein said keys are arranged so as to require only proximal-distal movement from the perspective of said user of said user's distal three fingers of each hand from each respective hand's thumb and to rely upon the index finger and thumb of each said hand to strike keys that require diagonal movement from the home key row to strike keys.
